(19) United States
(12) Patent Application Publication
(10) Pub. No.: US 2005/0019146 A1
(43) Pub. Date: Jan. 27, 2005

(54) Device for selectively displacing holding devices and fitting head for transporting components

(75) Inventors: Stefan Burger, Muenchen (DE); Robert Conrad, Sauerlach (DE); Harald Stanzl, Muenchen (DE)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 10/928,092

(22) Filed: Aug. 30, 2004

Related U.S. Application Data
(63) Continuation of application No. PCT/DE03/02562, filed on Jul. 30, 2003.

(30) Foreign Application Priority Data
Sep. 8, 2002 (DE) 102 36 626.8

(51) Int. Cl. B65G 1/133

(52) U.S. Cl. 414/752.1

(57) ABSTRACT

The present invention relates to a device for selectively displacing at least two holding devices which can be individually displaced along a z-axis by means of a central z-drive and by a selective magnetic coupling to a common lifting element. The exclusively magnetic coupling between the holding devices and the lifting element ensures a largely bounce-free displacement of the coupled holding devices, during the corresponding shock-free displacement of the lifting element. The coupling is especially advantageous during the transport of components as the bounce-free displacement from falling or sliding. The invention also relates to a fitting head for transporting a plurality of components, the holding devices being arranged along a line or on grid points of a two dimensional grid. The holding devices can be individually coupled to the movement of a common lifting element.

### CROSS REFERENCE TO RELATED APPLICATIONS

The present application is a continuation of international patent application PCT/DE2003/002562, filed Jul. 30, 2003, and claims priority to German patent application 10236626.8, filed Aug. 9, 2002. Both of the above applications are herein incorporated by reference.

### BACKGROUND OF THE INVENTION

The invention concerns a device for selectively displacing at least two holding devices, in particular holding devices for components which are transported from a retrieval position to a placement position as part of an assembly process. The invention further concerns a fitting head for transporting a plurality of components from a collection position to a placement position.

Nowadays components are usually automatically mounted on substrates or printed circuit boards using what are known as pick-and-place machines. With these machines components are transported from a collection position of a component supply device to a placement position by means of a fitting head. To achieve a high level of assembly efficiency the fitting heads have a plurality of holding devices by means of which a plurality of components is simultaneously held on the travel path between the component supply device and the placement position. Holding devices that have proved particularly successful are what are known as suction pipettes, which can reliably hold the components to be transported when a negative pressure is applied.

Especially in the case of fitting heads having a plurality of holding devices it is advantageous, owing to the mass inertia of the fitting head as a whole, not to move the whole of the fitting head in the direction of the substrate to be assembled when placing an individual component but to move only the holding device holding the appropriate component.

U.S. Pat. No. 5,743,001 discloses an assembly system having a plurality of holding devices arranged in one row or in two adjacent rows. Each holding device is rotatable about its longitudinal axis independently of the other holding devices. Each holding device is, moreover, independently of the other holding devices, movable along a z-axis representing the direction in which placement of the components occurs.

WO 96/12394 discloses a fitting head for a pick-and-place machine having a plurality of holding devices which are individually movable in a z direction by means of a common drive. This is achieved in that the individual holding devices can be mechanically coupled to the common drive as necessary so that, as the drive moves, there are moved selectively along the z-axis those holding devices which are coupled to the drive at that moment. The disadvantage of this is that, during coupling and uncoupling, the holding devices are each moved in a jerky manner. If the holding devices are subjected to bouncing in this way, there is the danger that components held by the holding device will fall off or slide off-center. The component in question is then lost from the assembly process, or a printed circuit board is incorrectly assembled.

### SUMMARY OF THE INVENTION

The object of the invention is to provide a device for selectively displacing at least two holding devices where largely bounce-free movement is ensured. A further object of the invention is to provide a fitting head for transporting a plurality of components where a plurality of holding devices is individually movable and the movements are likewise all largely bounce-free.

The first object of the invention is achieved by a device with the features of independent Claim 1. The invention is based on the perception that, when there is a central drive by which what is known as a lifting element is moved along the z-axis, individual holding devices can be selectively coupled to the predetermined movement of the lifting element in a virtually bounce-free manner if there is provided for each holding device an electromagnet which, with an appropriate flow of current, effects a magnetic attraction to the lifting element moved along the z-axis. The exclusively magnetic coupling of the individual holding devices to the central z drive, requiring no relative movement between the current-carrying electromagnet and the lifting element, can take place very quickly and with little wear and tear. A further advantage of the invention is the fact that an exclusively magnetic coupling unit according to the invention can be made in a very compact design.

The device according to Claim 2 has the advantage that a magnetic coupling between electromagnet and lifting element is ensured by the fact that only the electromagnet connected to the holding device and not an electromagnet rigidly connected to the lifting element carries a current. The resulting magnetic field then ensures that there is a magnetic interaction between the electromagnet and the magnetic material of the lifting element. A magnetic field does not therefore need to be generated by current-carrying electromagnets on the lifting element.

According to Claim 4, a lifting or holding mechanism can be used to hold the holding device preferably in a home position. A lifting mechanism can be achieved by means of a spring or a lifting cylinder. In this case, when the appropriate electromagnet is activated, the holding device is moved against the force exerted on the holding device by the lifting mechanism. A holding mechanism can be achieved by lateral clamping, for example by means of a piezoelectric element, or by the use of a magnetic clamp. In this case, once the holding mechanism has been released, the lifting element and holding device move together largely freely apart from the force of gravity and any friction forces that may be present.

The development defined in claim 5 has the advantage that no further mechanical intermediate members such as universal shafts, guide rollers, gear wheels or gears have to be connected between the common z drive and the lifting element. The use of a linear motor as common z drive has the advantage that the drive is largely wear-resistant and therefore requires little maintenance. The use of a spindle drive, a belt drive, a piezo motor and a pneumatic drive has the advantage that the common drive can be produced easily and in a compact design.

A particularly smooth movement pattern for the lifting element, and hence also a particularly smooth movement pattern for the magnetically coupled holding devices, is achieved according to Claim 6 in that the starting and/or braking process of the linear motor is generated by sinusoidal control of the linear motor. Any control of the linear motor other than sinusoidal can, of course, be used, provided that it leads to a steady movement pattern.

According to Claim 7, additional damping elements reliably ensure that bouncing of the holding device is largely prevented when the electromagnet is coupled to the lifting element.

According to Claim 10, the holding device preferably has in its upper portion a connecting rod which is mounted in a manner locked against rotation relative to the basic body.

The fact that the connecting rod is mounted in a manner locked against rotation enables there to be provided for each holding device, according to Claim 11, a rotation mechanism by means of which that portion of the holding device on which the components are held can be rotated about the z-axis. Rotation of the components about the z-axis enables, for example, an angle correction to be made. An angle correction of this kind is often necessary because the individual components lie at slightly different angles in the retrieval position prior to picking of the components, and because they generally have to be placed in different placement positions on the printed circuit board. The components to be mounted therefore have to be rotated through a specific angle about the z-axis after picking and before placing. This is the only way that the component connections can be reliably contacted with the contact faces provided on the printed circuit board.

The further object of the invention is achieved by a fitting head for transporting a plurality of components having the features of independent Claim 13. The fitting head according to the invention is based on the perception that a plurality of holding devices, each so mounted as to be displaceable along a z-axis, can be moved along the z-axis by means of a centrally controlled z drive, each individual holding device being able to be selectively coupled to a predetermined movement of the z drive by means of a magnetic coupling mechanism when a current flows through the appropriate electromagnet. The fitting head according to the invention has the advantage that the number of z drives required is far fewer than in the case of fitting heads where an individual z drive is provided for each holding device.

Depending on the number of holding devices, a considerable weight saving can thus be made and an increase in the resulting assembly efficiency can therefore be achieved. Compared with known fitting heads likewise having a central z drive and having a mechanical coupling of the individual holding devices to the z drive, the fitting head according to the invention has the advantage that the movement of the holding devices is largely bounce-free. The danger that components will fall off or slide off-center is then avoided and reliable transportation of the components is ensured. Compared with a conventional head known as a turret, where a plurality of holding devices is arranged in a star shape about a rotary axis, the fitting head according to the invention has the advantage that all the components located on the holding devices can be detected with a single camera. There is therefore no need for the coupled motion of a camera, as required with turrets, to detect the position and nature of the transported components, so an additional weight saving is achieved and assembly efficiency is thereby further enhanced. Compared with turrets, fitting heads according to the invention have the advantage that a plurality of components can be successively picked and placed without the plurality of holding devices having to be rotated about a rotary axis for this purpose. The centrifugal forces acting on the components are thus reduced, so the fitting head according to the invention can be moved from the retrieval position to the placement position at a greater acceleration than a turret, without the components held being lost in the process. Greater assembly efficiency can therefore be achieved with a fitting head according to the invention.

### BRIEF DESCRIPTION OF THE SEVERAL VIEWS OF THE DRAWINGS

Further advantages and features of the present invention will emerge from the exemplary description which follows of currently preferred embodiments, where:

FIG. 1 shows: in a diagrammatic view, a device for selectively displacing two holding devices;

FIG. 2 shows: a cross-sectional view of a fitting head on which 4×4 holding devices are arranged in a square matrix;

FIG. 3 shows: in an enlarged view, a holding device of the fitting head shown in FIG. 2; and

FIG. 4 shows: a view from below of the fitting head shown in FIG. 2.

### DETAILED DESCRIPTION OF THE INVENTION

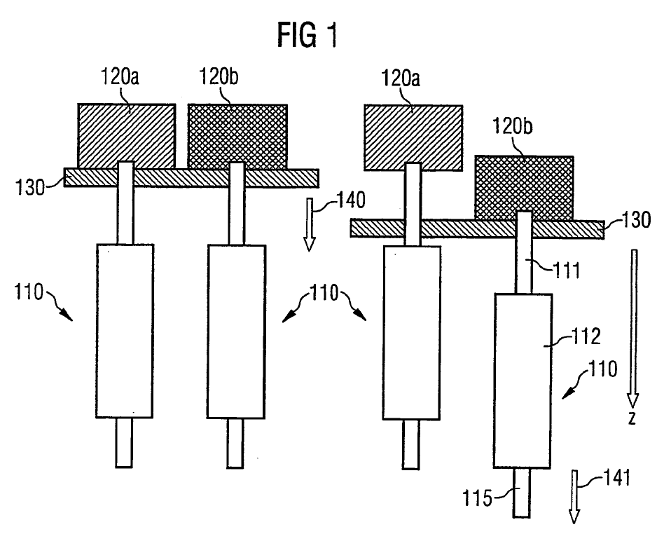

FIG. 1 shows a device for selectively displacing two holding devices 110, which can be moved in the z direction by means of a lifting plate 130. Each of the two holding devices 110 is rigidly connected to an electromagnet 120a or 120b. The two electromagnets 120a and 120b are hatched differently in FIG. 1 to make it clear that the electromagnet 120a is not carrying a current and that the electromagnet 120b is carrying a current. It therefore follows that only the electromagnet 120b generates a magnetic field and is therefore rigidly connected to the lifting plate 130, which is partially made from a ferromagnetic material to save weight. If the lifting plate 130 is moved downwards along the z-axis as indicated by the arrow 140, the electromagnet 120b and the holding device 110

connected to the electromagnet 120b also move downwards in the z direction as indicated by the arrow 141. The holding device 110 connected to the electromagnet 120a is held in the upper position by lifting mechanisms not shown in FIG. 1.

Each holding device 110 has a connecting rod 111 and a pipette holder 115. A negative pressure can be applied via the pipette holder 115 to a pipette (not shown), so a component can be held on each holding device 110. For each holding device 110 there is provided between the connecting rod 111 and the pipette holder 115 a rotation mechanism 112 by means of which the pipette holder 115 can be rotated about the z-axis relative to the connecting rod. A component held by the holding device 110 can therefore be rotated about the z-axis while being transported from a retrieval position to a placement position on a substrate.

It should be noted that any slight residual bouncing between lifting plate 130 and electromagnet 120b, generated when a current passing through the electromagnet 120b is switched on, is effectively prevented by the use of damping elements. A damping element can be, for example, an elastomer sheet which is secured to the lifting element and on which is fitted a ferromagnetic clamping disk to which the electromagnet 120b can couple without an air gap. The avoidance of an air gap has the advantage that the holding device 110 is coupled to the lifting plate 130 with a greater dynamic effect when the electromagnet 120b is appropriately activated.

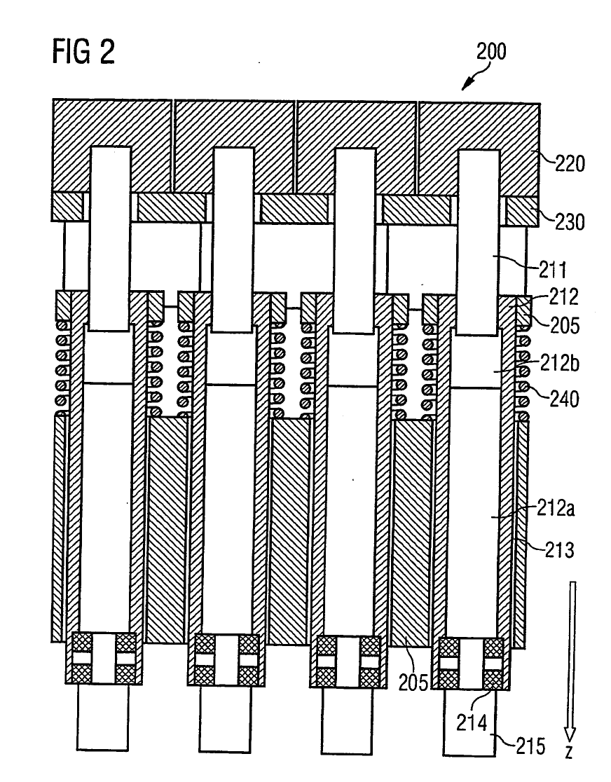

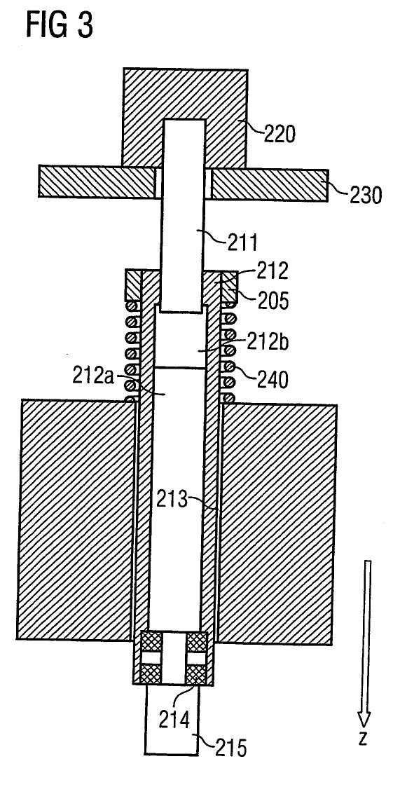

A fitting head according to an exemplary embodiment of the invention will be described below with reference to FIGS. 2, 3 and 4. The same reference characters will be used to denote the same components. FIG. 2 shows a cross-sectional view of a fitting head according to an exemplary embodiment of the invention, on which fitting head a total of 16 holding devices are arranged in a 4×4 matrix. FIG. 3 shows, in an enlarged view, one of the holding devices shown in FIG. 2. The fitting head 200 has a basic body 205. Relative to the basic body 205 holding devices are so mounted as to be movable along the z-axis. Each holding device has a connecting rod 211, a rotation mechanism 212, a pipette holder 215 and an electromagnet 220. The connecting rods 211 are so mounted relative to the basic body 205 as to be displaceable along the z-axis, a return spring 240 fixed between a clamping ring 206 and the basic body 205 being compressed during a downward displacement. Bearings that can be used are, in particular, wear-resistant aircushion bearings or linear ball bearings. In any event the bearings of the connecting rods 211 must be locked against rotation relative to the z-axis. According to the exemplary embodiment of the invention described here, the rotation mechanisms 212 are mounted in the basic body 205 in an aircushion bearing 213, which ensures that the holding devices are accurately guided when the lifting plate 230 is lowered.

The rotation mechanisms 212 each have a rotary actuator 212a and an angle measuring device 212b. The purpose of the rotary actuator 212a is to rotate the pipette holder 215 about the z-axis relative to the connecting rod 211. A component held on a pipette (not shown) can therefore be rotated about the z-axis relative to the basic body 205. The purpose of the angle measuring device 212b is to take precise measurements of the angle of rotation of a component generated by the rotary actuator 212a. This enables the angle of a component to be accurately corrected while it is being transported from a retrieval position to a placement position.

The vacuum required to enable components to be held can be supplied to the pipette holder 215 preferably in two ways:
(a) The vacuum is applied to a suction duct (not shown) formed in the rotation mechanism 212 and is transmitted to the pipette holder 215. When this happens, the vacuum in each case is preferably transmitted to the suction duct by means of a flexible tube which is attached to the rotation mechanism 212 in the region between the rotation mechanism 212 and the lifting plate 230. To prevent vacuum losses a seal is positioned between the rotary actuator 212a and the angle measuring device 212b. Between the rotation mechanism 212 and the pipette holder 215 there is positioned a largely vacuum-tight support 214.
(b) The vacuum required to enable components to be picked is applied laterally to the support 214 via tubes (not shown) and is transmitted to the pipette holder 215.

The fitting head 200 also has a lifting plate 230, which is made at least partially from a ferromagnetic material or to which ferromagnetic clamping disks are secured indirectly via damping elements. This makes it possible for those electromagnets 220 which, when an appropriate current flows, generate a magnetic field that attracts the lifting plate 230 to the electromagnet 220 to directly or indirectly couple firmly to the lifting plate 230.

To each holding device there is also assigned a return spring 240 which holds the holding device in an upper position in the home state. If the lifting plate 230 moves downwards along the z-axis and a current flows through the electromagnet 220, the holding device connected to the electromagnet 220 is moved downwards against the elastic force of the return spring 240. If the lifting plate is subsequently moved upwards in the z direction into the home position of the lifting plate 230, the return spring 240 ensures that the appropriate holding device is moved upwards even if the electromagnet no longer carries a current.

It should be noted that the return spring 240 can also be replaced by other lifting or holding mechanisms which ensure that, at least when the appropriate electromagnet is not activated, the holding device assigned to the electromagnet is held in the upper position.

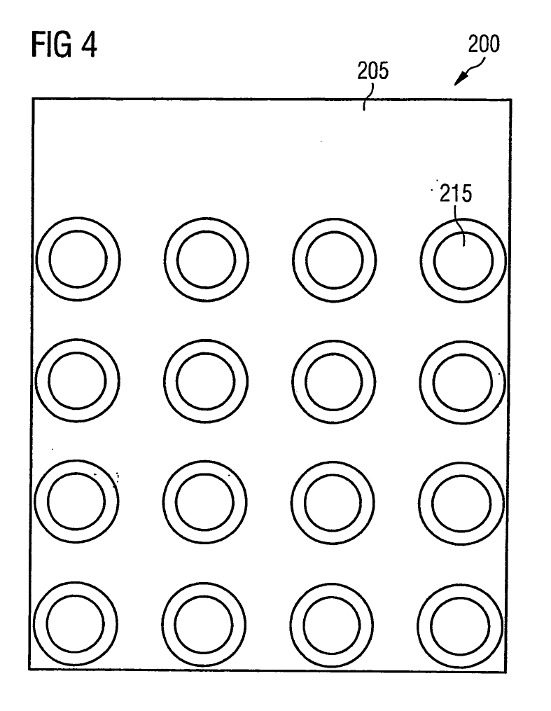

FIG. 4 shows a diagrammatic view from below of the fitting head 200 described with reference to FIGS. 2 and 3. This view shows the basic body 205, in which are arranged a total of 16 holding devices in a 4×4 matrix. The portion of the 16 holding devices visible in the view in FIG. 4 is in each instance the pipette holder 215, to which the suction pipettes (not shown) can be attached.

To summarize, the invention provides a device for selectively displacing at least two holding devices 110 which can be individually moved along a z-axis by means of a central z drive and by a selective magnetic coupling to a common lifting element 130. The exclusively magnetic coupling of the holding devices to the lifting element 130 ensures a largely bounce-free movement of the coupled holding devices 110 and corresponding smooth movement of the lifting element 130. This is especially advantageous during the transportation of components, since bounce-free movements of the holding devices 110 prevent components from falling off or sliding off-center. The invention also provides a fitting head 200 for transporting a plurality of components, where the holding devices 110 are arranged in a line or at the grid points of a two-dimensional grid. The holding devices 110 can be individually coupled to the movement of a common lifting element 130.

1. Device for selectively displacing at least two holding devices, in particular holding devices for components which are transported from a retrieval position to a placement position as part of an assembly process, having
a basic body,
a first holding device,
which, relative to the basic body, is so mounted as to be displaceable along a z-axis,
which is held by a first mechanism preferably in a home position and
to which is secured a first electromagnet,
a second holding device,
which, relative to the basic body, is so mounted as to be displaceable along the z-axis,
which is held by a second mechanism preferably in a home position and
to which is secured a second electromagnet,
a lifting element, which is movable along the z-axis by means of a drive and to which the two electromagnets can be magnetically coupled when appropriately activated so that the holding device assigned to the activated electromagnet is displaced along the z-axis together with the lifting element.

2. Device according to claim 1, wherein the lifting element has a plate made from a ferromagnetic material.

3. Device according to claim 1, designed so that the holding devices,
if the electromagnets are not activated, are held by the mechanisms in an upper position and,
if the appropriate electromagnets are activated, are moved downwards along the z-axis when the lifting element is lowered.

4. Device according to claim 1, wherein the mechanism is a lifting mechanism and/or a holding mechanism.

5. Device according to claim 1, wherein the drive is a linear motor, a spindle drive, a belt drive, a piezo motor and/or a pneumatic drive.

6. Device according to claim 1, wherein the drive is designed in such a way and/or the drive is controlled in such a way that the movement pattern of the lifting element has exclusively steady acceleration patterns.

7. Device according to claim 1, wherein there is additionally provided for the lifting element a damping element, by means of which bouncing of the holding device is at least reduced during the coupling process.

8. Device according to claim 7, wherein the damping element is an elastomer sheet and/or a damped spring element.

9. Device according to claim 1, wherein the holding device has a pipette holder arranged along the z-axis and has a suction pipette which is attached to the pipette holder and onto which a component to be transported can be sucked when a negative pressure is applied.

10. Device according to claim 9, wherein the holding device additionally has a connecting rod mounted relative to the basic body so as to prevent the connecting rod from rotating about the z-axis.

11. Device according to claim 10, wherein the holding device additionally has a rotation mechanism which is arranged between the connecting rod and the pipette holder and by means of which the suction pipette can be rotated about the z-axis relative to the basic body.

12. Device according to claim 11, wherein there is additionally provided for the rotation mechanism a measuring device by means of which the angle of rotation of the suction pipette relative to the basic body can be detected.

13. Fitting head for transporting a plurality of components from a respective collection position to a respective placement position, with a device having a plurality of holding devices arranged in a row or at the grid points of a two-dimensional grid.

12. Fitting head according to claim 13 wherein the two-dimensional grid is a rectangular matrix.

13. Fitting head according to claim 12, wherein the matrix has two or more rows and two or more columns.
